(19) United States
(12) Patent Application Publication
(10) Pub. No.: US 2012/0255311 A1
(43) Pub. Date: Oct. 11, 2012

(54) COOLING STRUCTURE, GAS TURBINE COMBUSTOR AND MANUFACTURING METHOD OF COOLING STRUCTURE

(76) Inventor: Yoshiaki MIYAKE, Tokyo (JP)

(21) Appl. No.: 13/241,594

(22) Filed: Sep. 23, 2011

(30) Foreign Application Priority Data
Apr. 6, 2011 (JP) 2011-084562

(51) Int. Cl. F02C 7/12; F28F 7/00; B23P 15/26

(52) U.S. Cl. 60/806; 29/890.035; 165/185

(57) ABSTRACT

A cooling structure, a gas turbine combustor, and a method of manufacturing the cooling structure attain a high cooling efficiency without increasing manufacturing cost. The cooling structure includes a first member as a cooling object having a first plane, and a second member arranged above the first plane and having an opposing second plane such that a passage is formed between the first plane and the second plane for a cooling medium to flow. The first member has a plurality of prominences each of which extends upwardly from the first plane, and extends to be inclined along a direction in which the cooling medium flows. A clearance between the second plane and a tip of each prominence is set such that a heat transfer rate between the cooling medium and the first member becomes larger than that when each prominence extends vertically upward from the first plane.

### INCORPORATION BY REFERENCE

This patent application claims a priority on convention based on Japanese Patent Application No. 2011-084582. The disclosure thereof is incorporated herein by reference.

### TECHNICAL FIELD

The present invention is related to a cooling structure, a gas turbine combustor and a method of manufacturing the cooling structure.

### BACKGROUND TECHNIQUES

In a combustor provided for a gas turbine, a cooling structure is provided as a wall structure of a combustion chamber. FIG. 1 is a diagram showing an example of such a cooling structure. The cooling structure shown in FIG. 1 is provided with a cooling panel 101 and a shell 103. The cooling panel 101 is arranged to oppose to the shell 103. Between the cooling panel 101 and the shell 103, a passage 104 is formed so as to pass a cooling air therethrough. Also, a plurality of pin fins 102 are provided for the cooling panel 101. The plurality of pin fins 102 are arranged in the passage 104 and extend upwardly in a vertical direction from the cooling panel 101.

In the cooling structure shown in FIG. 1, the cooling panel 101 is cooled by the cooling air which flows through the passage 104. Here, because the plurality of pin fins 102 are provided, a turbulent flow is generated in the cooling air and a heat exchange between the cooling panel 101 and the cooling air is promoted. With this, the cooling efficiency can be improved.

In conjunction with the above, a heat exchange bulkhead is disclosed in Patent Literature 1 (US 2005/0047932 A1), and is provided with a plurality of protrusions extending upwardly in a vertical direction from a base member.

Also, in Patent Literature 2 (JP S62-271902A), a gas turbine blade and vane are disclosed, which has a cooling passage of an inner retention cooling system partitioned by a leading edge wall in a leading edge region of the blade and vane, a back wall, a side wall and an internal bulkhead. In the gas turbine blade and vane, there are arranged a plurality of columnar prominences of a one-end fixation type or a plurality of columnar bodies of a both-end fixation type. The columnar prominences and the columnar bodies are arranged on positions near to the internal bulkhead in the cooling passage rather than the leading edge wall to oppose to a cooling fluid. Also, the columnar prominences protrude from one end or both ends of the back wall and the side wall to the opposing plane, and the columnar bodies pass through the passage. Also, in Patent Literature 2, the columnar prominences and the columnar bodies are inclined to lead the flow of the cooling fluid to the leading edge wall.

### CITATION LIST

[Patent Literature 1]: US 2005/0047932 A1
[Patent Literature 2]: JP S62-271902A

### SUMMARY OF THE INVENTION

When the cooling structure is manufactured as shown in FIG. 1, there is a case that a variation of heights is caused in the plurality of pin fins 102. When the variation is caused, a space is produced between each of the plurality of pin fins 102 and the shell 103. When the space is produced, the cooling air is easy to flow through the passage 104 and is difficult to flow in the neighborhood of the cooling panel 101. As a result, the cooling efficiency is lowered. To prevent generation of the space, a high manufacture precision is required in case of manufacturing the plurality of pin fins 102, which is disadvantage from the point of a manufacturing cost.

Therefore, one subject matter of the present invention is to provide a cooling structure, a gas turbine combustor, and a method of manufacturing the cooling structure, in which a high cooling efficiency can be attained without increasing the manufacturing cost.

The cooling structure according to the present invention includes: a first member as a cooling object having a first plane; and a second member arranged above the first plane to have a second plane to oppose to the first plane such that a passage is formed between the first plane and the second plane for a cooling medium to flow. The first member includes a plurality of prominences which extend upwardly from the first plane. Each of the plurality of prominences extends to be inclined along a direction in which the cooling medium flows. A maximum value of a clearance between the second plane and a tip of each prominence is set such that a heat transfer rate between the cooling medium and the first member becomes larger than a heat transfer rate when each prominence extends upwardly in a vertical direction from the first plane.

The inventor of the present invention discovered that a heat transfer rate between a cooling medium and a cooling object reduces greatly as a clearance becomes larger, when a plurality of prominences extend upwardly in a vertical direction, and that the heat transfer rate does not reduce so much even if the clearance becomes larger, when the plurality of prominences are inclined and extend. The above-mentioned invention uses this point. That is, in the above-mentioned invention, a value of the maximum allowable clearance is set such that the heat transfer rate between the cooling medium and the first member becomes larger than the heat transfer rate when each of the prominences extends upward in the vertical direction from a first surface. Thus, if the maximum allowable clearance is set to have such a value, the heat transfer rate between the cooling medium and the first member can be maintained. That is, while maintaining the cooling efficiency, the manufacturing cost can be restrained.

A gas turbine combustor of the present invention includes: a combustor case into which a compressed air is introduced; a combustor liner provided in the combustor case tube, wherein the compressed air is introduced through the combustor case into the combustor liner; and a fuel supply mechanism configured to supply fuel into the combustor liner. A wall section of the combustor liner the above cooling structure. An internal space of combustor liner is connected with a gas turbine.

A method according to the present invention of manufacturing a cooling structure includes: a first member as a cooling object having a first plane; and a second member arranged above the first plane to have a second plane to oppose to the first plane such that a passage is formed between the first plane and the second plane for a cooling medium to flow. The first member includes a plurality of prominences which extend upwardly from the first plane, and each of the plurality of prominences extends to be along a direction in which the cooling medium flows. The manufacturing method includes: measuring as a first relation, a relation of a clearance formed between a tip of each of the plurality of prominences and the second plane and a heat transfer rate between the cooling medium and the first member, when each prominence is inclined along a direction in which the cooling medium flows; measuring as a second relation, a relation of a clearance and a heat transfer rate when each prominence extends upwardly in a vertical direction from the first plane; determining as maximum allowable clearance, the clearance based on the first relation and the second relation such that the heat transfer rate when each prominence is inclined becomes larger than the heat transfer rate when each prominence extends upwardly in the vertical direction; and providing the second member on the first plane such that a clearance between each of the plurality of prominences and the second plane is equal to or less than the maximum allowable clearance.

According to the present invention, the cooling structure, the gas turbine combustor, and the method of manufacturing the cooling structure are provided to attain a high cooling efficiency without increasing the manufacturing cost.

### BRIEF DESCRIPTION OF THE DRAWINGS

FIG. 1 is a diagram showing an example of a conventional cooling structure;

FIG. 2 is a diagram showing a combustor of a gas turbine according to a first embodiment;

FIG. 3 is a perspective view showing a cooling panel;

FIG. 4 is a sectional view showing the cooling structure;

FIG. 5A is a graph showing an example of a relation between a rate of the clearance b and a heat transfer rate;

FIG. 5B is a diagram showing an example of a method of determining a maximum allowable clearance;

FIG. 6A is a diagram showing a simulation result of a flow of cooling air;

FIG. 6B is a diagram showing a simulation result of a flow of cooling air;

FIG. 6C is a diagram showing a simulation result of a flow of the cooling air;

FIG. 6D is a diagram showing a simulation result of a flow of cooling air;

FIG. 6E is a diagram showing a simulation result of a flow of a cooling air;

FIG. 7A is a schematic showing the cooling structure when a unevenness degree is 1;

FIG. 7B is the schematic showing the cooling structure when the unevenness degree is 2;

FIG. 8 is a flow chart showing a manufacturing method of the cooling structure; and

FIG. 9 is a schematic showing the cooling structure according to a second embodiment.

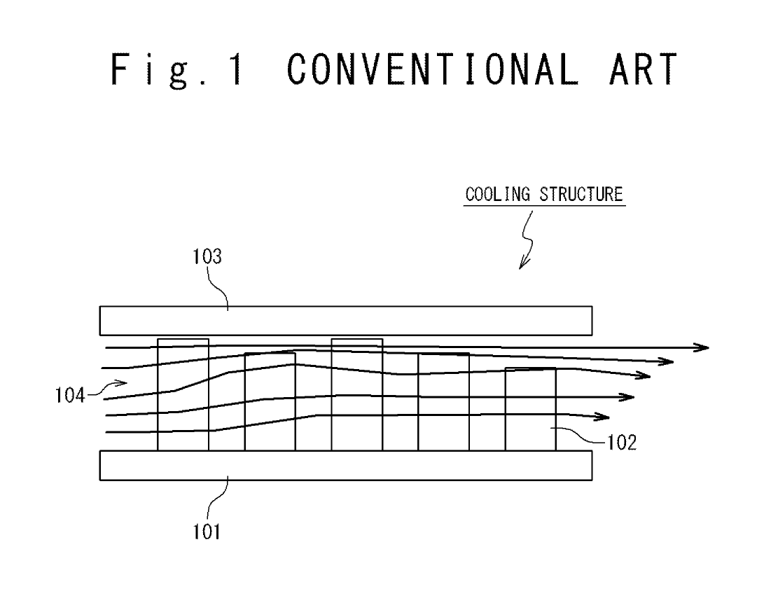

### DESCRIPTION OF EMBODIMENTS

Hereinafter, the present invention will be described with reference to the attached drawings.

### First Embodiment

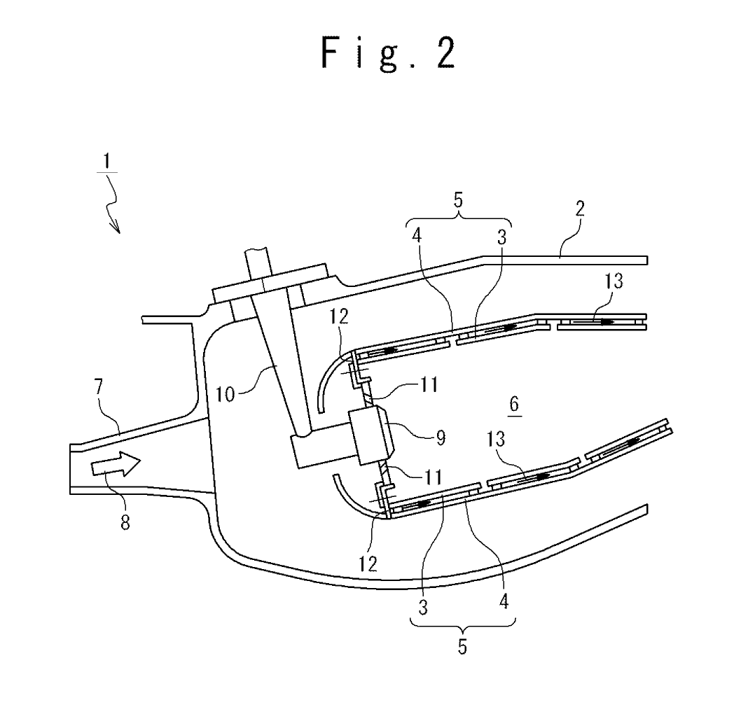

FIG. 2 is a diagram showing a gas turbine combustor 1 according to an embodiment of the present invention. In the gas turbine combustor 1, compressed air is taken in from a compressor (not shown) and fuel is supplied into the compressed air for combustion. Thus, a combustion gas is generated, and is supplied to a turbine (not shown). Thus, the turbine is driven. For example, the gas turbine combustor 1 is used for a gas turbine for aircraft.

As shown in FIG. 2, the gas turbine combustor 1 is provided with a combustor case 2, a combustor liner 5 and a fuel supply mechanism 10.

An air inlet 7 is provided for the combustor case 2. The compressed air 8 is supplied from the compressor (not shown) into the inside of the combustor case 2 through the air inlet 7.

The combustor liner 5 is arranged inside the combustor case 2. An internal space of the combustor liner 5 forms a combustion chamber 6. An air inlet 11 is provided for the combustor liner 5 and the compressed air 8 is taken into the combustion chamber 6 through the air inlet 11. A downstream side portion of the combustion chamber 6 is connected with the entrance of a turbine (not shown).

The fuel supply mechanism 10 has a function to supply fuel into the combustion chamber 6. A fuel nozzle 9 is provided for a tip of the fuel supply mechanism 10. The fuel nozzle 9 is arranged to supply the fuel to the inside of the combustion chamber 6.

In the gas turbine combustor 1, the compressed air 8 is introduced into the combustor case 2 through the air inlet 7. The compressed air 8 is introduced into the combustion chamber 6 through the air inlet 11. The fuel is supplied to the combustion chamber 6 through the fuel nozzle 9. The fuel burns in the combustion chamber 6 and the combustion gas is generated. The generated combustion gas is supplied to the turbine and the turbine is driven.

Here, a shell 4 (a second member) is provided for a wall section of the combustor liner 5 as an outer wall, and a cooling panel 3 (a first member) is provided inside the shell 4. The cooling structure according to the present embodiment is formed by the shell 4 and the cooling panel 3. A space (a passage) is formed between the shell 4 and the cooling panel 3. The space is connected with cooling air inlets 12 or cooling air holes (not shown) provided for the shell 4. The compressed air 8 which is taken into the combustor case 2 is supplied to the space as the cooling air 13 through the cooling air inlets 12 or the cooling air holes. In the space, a heat exchange is performed between the cooling air 13 (cooling medium) and the cooling panel 3 so that the cooling panel 3 is cooled.

Here, in the present embodiment, the configuration of the cooling structure is devised. Below, the cooling structure will be described in detail.

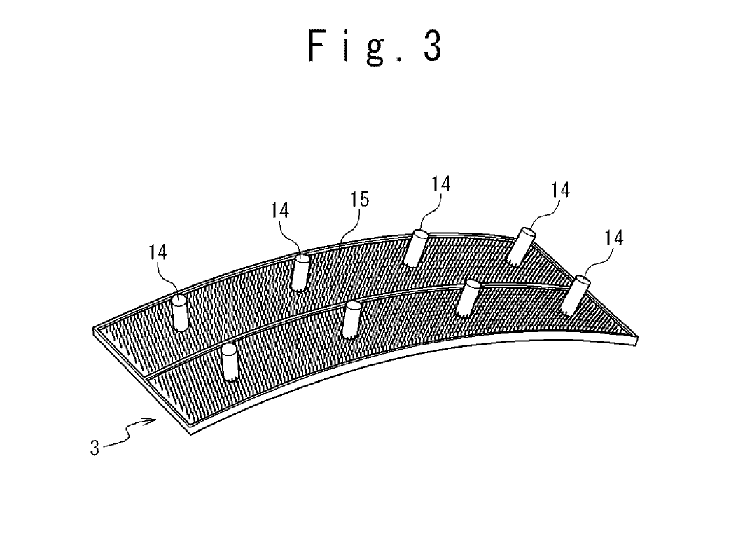

FIG. 3 is a perspective view showing the cooling panel 3. As shown in FIG. 3, the cooling panel 3 is tabular and a plurality of screwing sections 14 and a plurality of pin fins 15 (prominences) are provided for the upper surface (a first surface). The plurality of screwing sections 14 are provided to attach the cooling panel 3 to the shell 4 and to extend upwardly in a vertical direction from the first surface. Although not shown, an opening is provided for a position of the shell 4 corresponding to each of the plurality of screwing sections 14. Each of the plurality of screwing sections 14 is inserted in the opening provided for the shell 4, so that the cooling panel 3 is attached to the shell 4.

On the other hand, the plurality of pin fins 15 are provide to promote the heat exchange between the cooling air and the cooling panel 3.

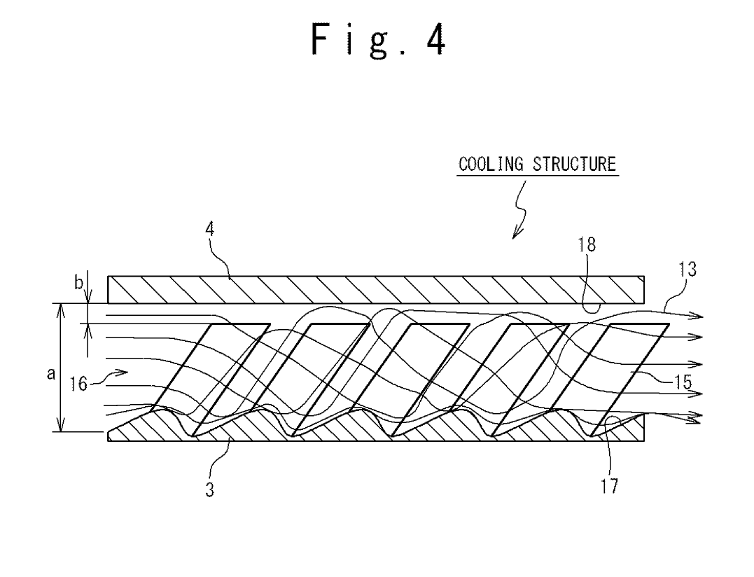

FIG. 4 is a sectional view showing the cooling structure. As previously mentioned, the cooling structure is provided with the cooling panel 3 and the shell 4. The cooling panel 3 is provided with a surface (the first surface 17). On the other hand, the shell 4 is provided with a lower surface (a second surface 18). The cooling panel 3 and the shell 4 are arranged for the first surface 17 and the second surface 18 to oppose to each other. The distance between the first surface 17 and the second surface 18 is a first distance a. Also, as previously mentioned, between the cooling panel 3 and the shell 4, the passage 16 is formed so as to pass the cooling air 13 therethrough. The cooling air 13 flows into a constant direction in the passage 16.

As shown in FIG. 4, the first surface 17 is formed have a wave shape when being viewed from the section of the cooling panel 3 along the flow direction of the cooling air 13. Also, the plurality of pin fins 15 are provided on the first surface 17 to extend upwardly to rise from the first surface 17. Each of plurality of pin fins 15 is inclined in the flow direction of the cooling air 13. A clearance b is provided between the vertex of each pin fin 15 and the second surface 18.

As mentioned above, because each pin fin 15 is inclined, the flow of cooling air 13 is turned to the side of the cooling panel 3 by each pin fin 15. Thus, the cooling air 13 is easy to flow through the neighborhood of the cooling panel 3, so that a heat exchange between the cooling air 13 and the cooling panel 3 is promoted to cool the cooling panel 3 effectively. It should be noted that it is desirable that an angle between a direction in which each pin fin 15 extends and the first surface 17 is not smaller than 30° and not larger than 60°.

In addition, because the first surface 17 has a wave shape, the flow of cooling air 13 is changed in the flow direction and hits the inclined slope of the first surface 17. As a result, the cooling panel 3 can be more effectively cooled.

Moreover, in the present embodiment, a maximum allowable value (maximum allowable clearance) of the clearance b is set to an appropriate value. The heights of the plurality of pin fins 15 have a distribution due to the manufacture precision. Therefore, the clearances b which is formed between the vertex of each pin fin 15 and the second surface 18 has a distribution. In the present embodiment, the maximum allowable clearance is set such that a heat transfer rate between the cooling air 13 and the cooling panel 3 when each pin fin 15 is inclined is larger than the heat transfer rate when each pin fin 15 extends straightly upwardly. This point will be described below.

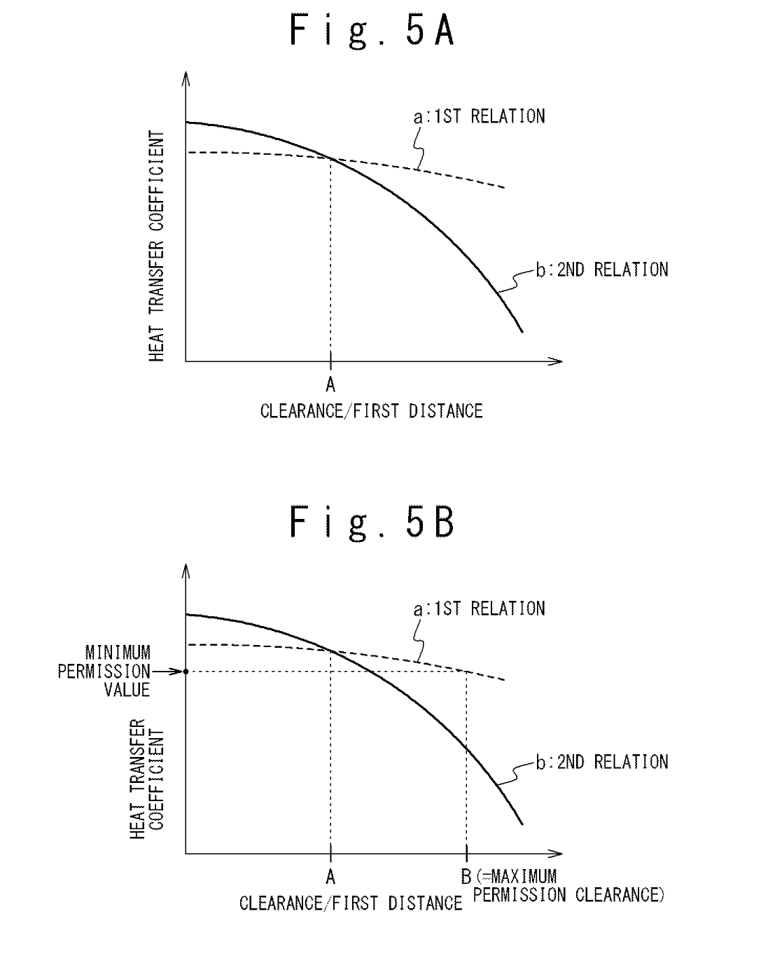

FIG. 5A is a graph showing an example of a relation of a rate (%) of the clearance b to first distance a and the heat transfer rate. The relation (a first relation a) when each pin fin 15 is inclined and the relation (a second relation b) when each pin fin 15 extends straightly upwardly are shown in FIG. 5A. As shown in FIG. 5A, when the clearance b is smaller, the heat transfer rate is larger in the case that each pin fin 15 extends straightly upwardly than in the case that each pin fin 15 is inclined. However, as shown by second relation b, when each pin fin 15 extends straightly upwardly, the heat transfer rate decreases more greatly as the clearance b becomes larger. On the other hand, as the shown by the first relation a, when each pin fin 15 is inclined, even if the clearance b became larger, the heat transfer rate decreases scarcely. In a region where the clearance b is larger than a value A, the heat transfer rate is higher in the case that each pin fin 15 is inclined than in the case that each pin fin 15 extends straightly upwardly. That is, in the present embodiment, the clearance b is set to a value equal to or larger than the value A. It should be noted that, when the angle between the first surface 17 and each pin fin 15 is 45°, the value A is 5%.

When each pin fin 15 is inclined, pressure loss per one pin fin 15 reduces. Therefore, the pressure difference becomes small between the upstream side and the downstream side with respect to each pin fin 15. As a result, the flow rate of the cooling air 13 which flows through the clearance b reduces. Thus, it could be considered that the heat transfer rate reduces scarcely even if the clearance b is large to some extent in size.

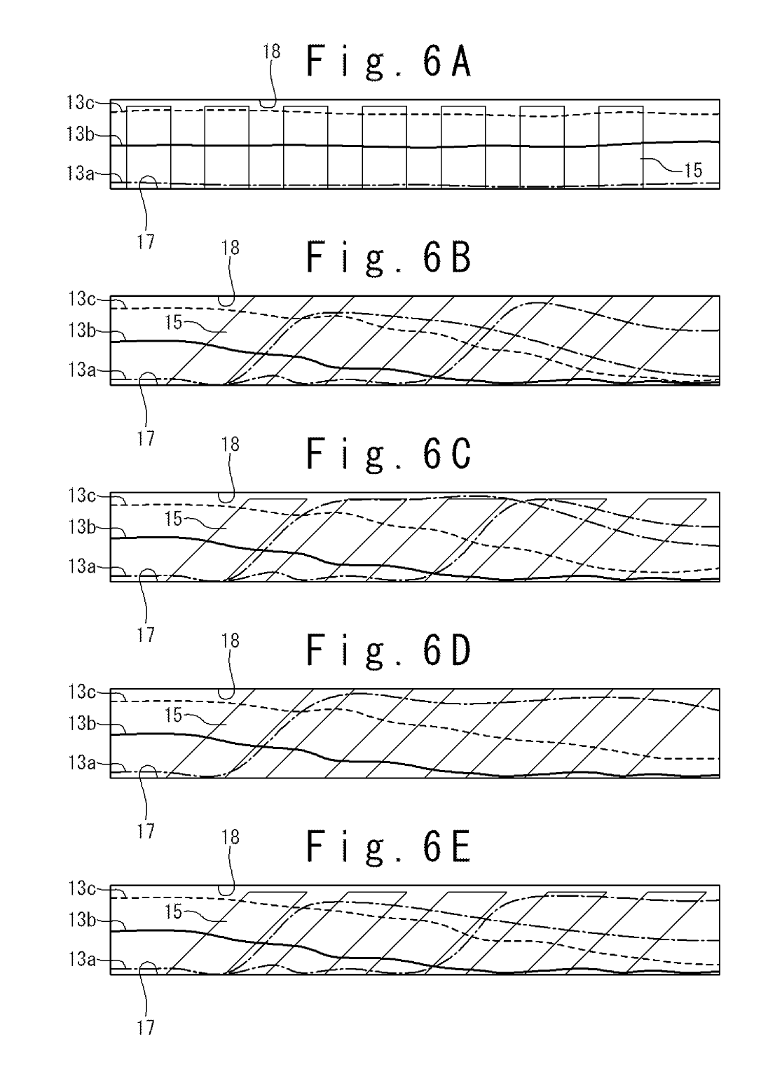

FIG. 6A to FIG. 6E are diagrams showing the simulation results of the flow of the cooling air 13. In FIG. 6A, the simulation result is shown when the first surface 17 is a flat plane, a rate of the clearance b is about 10%, and each pin fin 15 extends straightly upwardly. In FIG. 6B, the simulation result is shown when an unevenness degree of the first surface 17 is 2, the clearance b is zero and an angle (hereinafter, to be referred to as an inclination angle) between each pin fin 15 and the first surface 17 is 45°. In FIG. 6C, the simulation result is shown when the unevenness degree of the first surface 17 is 2, a rate of the clearance b is about 10% and the inclination angle is 45°. In FIG. 6D, the simulation result is shown when the unevenness degree of the first surface 17 is 1, a rate of the clearance b is zero and the inclination angle is 45°. In FIG. 6E, the simulation result is shown when the unevenness degree of the first surface 17 is 1, a rate of the clearance b is about 10% and the inclination angle is 45°.

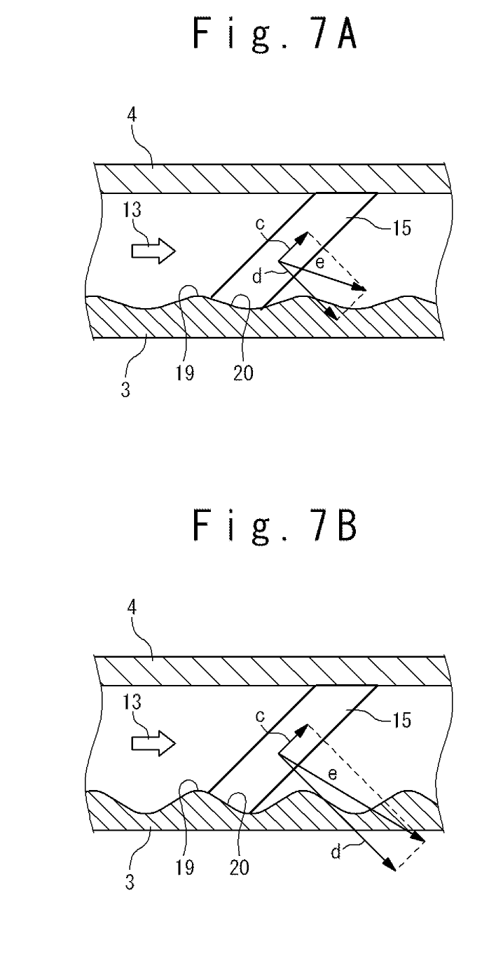

It should be noted that, the unevenness degree is a parameter showing the inclination of the slope which extends from the vertex of the convex portion to the downstream side when the first surface 17 is a wave type. FIG. 7A is a schematically showing the cooling structure when the unevenness degree is 1. In FIG. 7A, a vector c along the direction in which each pin fin 15 extends is defined and a vector d along a direction orthogonal to the direction of the vector c is defined. The length of the vector c is 1 and the length of the vector d is 2. A synthetic vector of the vector c and the vector d is defined as a vector e. The slope 20 which extends from the vertex 19 to the downstream side in the first surface 17 is formed to be parallel to the vector e. On the other hand, FIG. 7B is a schematically showing the cooling structure when the unevenness degree is 2. Like FIG. 7A, in FIG. 7B, the vector c along the direction in which each pin fin 15 extends is defined, and the vector d along the direction orthogonal to the direction c is defined. The length of the vector c is 1 and the length of the vector d is 4. A synthetic vector of the vector c and the vector d is defined as a vector e. The slope 20 which extends from the vertex 19 to the downstream side in the first surface 17 is formed to be parallel to the vector e.

Again, referring to FIG. 6A to FIG. 6E, there are shown a flow of the cooling air 13a introduced in the neighborhood of the cooling panel 3, a flow of the cooling air 13b introduced in the middle portion between the cooling panel 3 and the shell 4, and a flow of the cooling air 13c introduced in the neighborhood of the shell 4. As shown in FIG. 6A, when the first surface 17 is a flat plane, a rate of the clearance b is about 10%, and each pin fin 15 extends straightly upwardly, the introduced cooling air 13a continues to flow through the neighborhood of the cooling panel 3. The cooling air 13b continues to flow through a middle portion between the shell 4 and the cooling panel 3. The cooling air 13c continues to flow through the clearance b portion (the neighborhood of the shell 4). Therefore, a heat exchange is carried out between the cooling panel 3 and the cooling air 13a, but it is difficult for the heat exchange to be carried out between the cooling air 13b and the cooling air 13c and the cooling panel 3.

On the other hand, as shown in FIG. 6B, when each pin fin 15 is inclined, the cooling air 13b and the cooling air 13c are turned toward the cooling panel 3 by each pin fin 15. As a result, the mixing of the cooling airs 13a to 13c is promoted and a heat exchange between the cooling panel 3 and the cooling air 13 is promoted.

Also, in an example shown in FIG. 6C, although the clearance b is provided, the mixing of the cooling air 13 is promoted, like the example shown in FIG. 6B. That is, it could be understood that the heat exchange is promoted because each pin fin 15 is inclined, even if the clearance b is provided. Also, even in examples shown in FIG. 6D and FIG. 6E, the same tendency as the examples shown in FIG. 6B and FIG. 6C is confirmed. That is, it could be understood that even if the clearance b is provided, the heat exchange can be promoted even if the unevenness degree is changed because each pin fin 15 is inclined.

As described above, according to the present embodiment, a maximum allowable clearance is set such that the heat transfer rate between the cooling air and the cooling panel 3 become larger than the heat transfer rate when each pin fin 15 extends straightly upwardly. Because the maximum allowable value of the clearance b can be set to a large value, the manufacture precision required in manufacturing can be restrained. In addition, as shown in FIG. 5A, although the maximum allowable value of the clearance b is set to the large value, the reduction of the heat transfer rate is small and the cooling efficiency reduces scarcely. That is, the manufacturing cost can be restrained while maintaining good cooling efficiency.

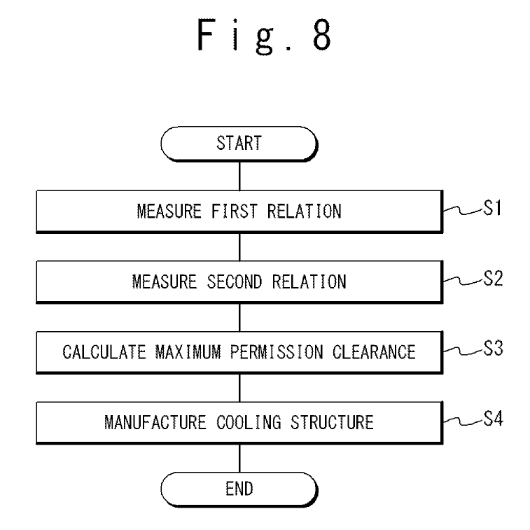

Next, a manufacturing method of the cooling structure according to the present embodiment will be described. FIG. 8 is a flow chart showing the manufacturing method of the cooling structure according to the present embodiment.

Step S1: Measurement of First Relation

First, the first relation a (reference to FIG. 5A) is measured. That is, when each pin fin 15 is inclined along the direction of a flow of the cooling air, the relation of the heat transfer rate between the cooling air and the cooling panel 3 and the clearance b is measured.

For example, the first relation a can be measured by using a naphthalene sublimation method. When using the naphthalene sublimation method, a model of the cooling panel 3 having the inclined pin fins 15 is first formed of naphthalene. The model does not have to be the model of a full scale and may be an expansion model. For example, the model can be attained by mold shaping. For example, the surface shape of the formed model is measured by a laser displacement measuring instrument and so on. Next, the periphery of the formed model is covered with a covering member such that the passages 16 (reference to FIG. 4) are formed. At this time, the model is covered such that the clearance b is formed. After that, the cooling air is introduced into the formed passage 16 for a predetermined time. After a predetermined time elapses, the surface shape of the model is measured again. Then, a change amount of the surface shape before and after the introduction of the cooling air is determined and the heat transfer rate is determined based on the change amount. By repeating the above processing while changing size of the clearance b, the first relation a can be measured.

Step S2: Measurement of Second Relation

Next, the second relation a (reference to FIG. 5A) is measured. That is, in case that each pin fin 15 extends straightly upwardly from the first surface, the relation of the clearance b and the heat transfer rate is measured. The second relation a can be measured by the same method as the first relation.

Step S3: Calculation of Maximum Allowable Clearance

Next, a maximum value of the clearance b is determined as a maximum allowable clearance based on the first relation a and the second relation b such that the heat transfer rate when each pin fin 15 is inclined is larger than the heat transfer rate in the maximum allowable clearance when each pin fin 15 extends straightly upwardly. That is, when the relation as shown in FIG. 5A is obtained, a value which is larger than the value A is determined as maximum allowable clearance.

FIG. 5B is a diagram showing an example of a method of determining the maximum allowable clearance. It is supposed that the minimum allowable value of the heat transfer rate is previously set, as shown in FIG. 5B. It is supposed that a value of the clearance corresponding to the minimum allowable value of heat transfer rate in the first relation a is B. In this case, the value B is determined as the maximum allowable clearance.

Step S4: Manufacturing Cooling Structure

After that, the cooling panel 3 is manufactured such that the clearance b actually formed is equal to or lower than the maximum allowable clearance determined at step S3, and is attached to the shell 4. For example, when the maximum allowable clearance determined at step S3 is 10%, the cooling structure is manufactured such that the actual clearance b is equal to or less than 10%. After that, the cooling structure is attached to the shell, it is confirmed whether or not the clearance actually formed becomes is equal to or lower than the maximum allowable clearance. When the actual clearance b is not equal to or less than 10%, a necessary handling is carried out, e.g. the cooling panel 3 is handled as the defective.

As described above, the cooling structure according to the present embodiment is obtained through the steps S1 to S4. According to the present embodiment, the heat transfer rate become larger than the minimum allowable value of the heat transfer rate when each pin fin 15 extends straightly upwardly. A maximum value of the clearance b, i.e. the maximum allowable clearance is set. Therefore, when manufacturing the cooling structure, the high manufacture precision is never required and a manufacturing cost can be restrained. Also, even if the clearance b to some extent is provided, the high heat transfer rate can be maintained and the cooling efficiency can be maintained.

### Second Embodiment

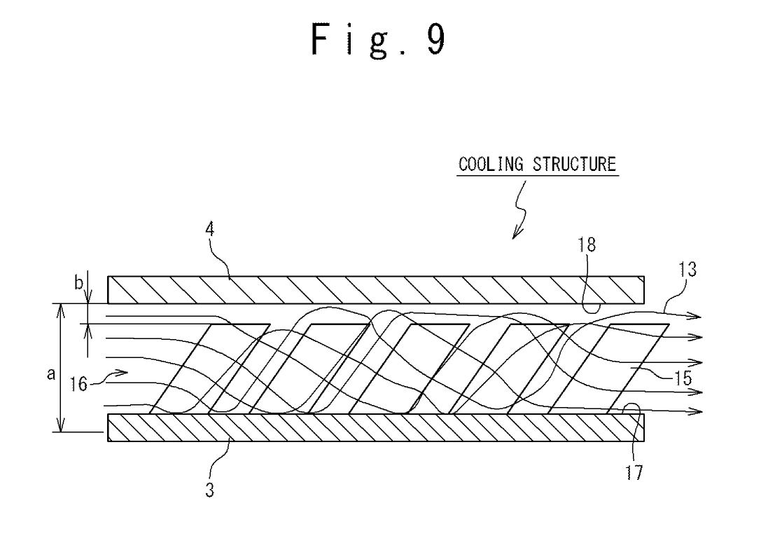

Next, a second embodiment will be described. FIG. 9 is a diagram schematically showing the cooling structure according to the present embodiment. In the present embodiment, the configuration of the first surface 17 of the cooling panel 3 is changed from the first embodiment. Because the same configuration as in the first embodiment can be adopted for the other points, the detailed description is omitted.

As shown in FIG. 9, in the present embodiment, the first surface 17 is a flat plane. When each pin fin 15 is inclined along a direction of a flow of the cooling air 13, the cooling air 13 is turned to the cooling panel 3 due to each pin fin 15 and collides diagonally to the first surface 17. Therefore, it would be considered that the cooling efficiency becomes lower, comparing with the first embodiment. However, in the present embodiment, because the maximum allowable value of the clearance b is appropriately set, it is possible to restrain the manufacturing cost while maintaining the cooling efficiency.

What is claimed is:

1. A cooling structure comprising:
a first member as a cooling object having a first plane; and
a second member arranged above said first plane to have a second plane opposing to said first plane such that a passage is formed between said first plane and said second plane to pass a cooling medium through said passage,
wherein said first member comprises a plurality of prominences which extend upwardly from said first plane,
wherein each of said plurality of prominences extends to be inclined along a direction a flow of said cooling medium,
wherein a clearance between said second plane and a tip of said each prominence is smaller than a maximum allowable clearance, and
wherein said maximum allowable clearance has a value, at which a heat transfer rate between said cooling medium and said first member when said each prominence is inclined becomes larger than a heat transfer rate when said each prominence extends straightly upwardly in a vertical direction from said first plane.

2. The cooling structure according to claim 1, wherein a distance between said first plane and said second plane is a first distance, and a rate of said maximum allowable clearance to said first distance is equal to or more than 5%.

3. The cooling structure according to claim 1, wherein said first plane is formed to have a wave-like shape when a section of said first member is viewed along a direction of the flow of said cooling medium.

4. The cooling structure according to claim 1, wherein an angle between said each prominence and said first plane is in a range equal to or more than 30° and equal to or less than 60°.

5. A gas turbine combustor comprising:
a combustor case into which a compressed air is introduced;
a combustor liner provided in said combustor case, wherein the compressed air is introduced through said combustor case into said combustor liner; and
a fuel supply mechanism configured to supply fuel into said combustor liner,
wherein a wall section of said combustor liner comprises a cooling structure,
an internal space of said combustor liner is connected with a gas turbine,
wherein said cooling structure comprises:
a first member as a cooling object having a first plane; and
a second member arranged above said first plane to have a second plane opposing to said first plane such that a passage is formed between said first plane and said second plane to pass a cooling medium through said passage,
wherein said first member comprises a plurality of prominences which extend upwardly from said first plane,
wherein each of said plurality of prominences extends to be along a direction a flow of said cooling medium,
wherein a clearance between said second plane and a tip of said each prominence is smaller than a maximum allowable clearance, and
wherein said maximum allowable clearance has a value, at which a heat transfer rate between said cooling medium and said second member when said each prominence is inclined becomes larger than a heat transfer rate when said each prominence extends straightly upwardly in a vertical direction from said first plane.

6. The gas turbine combustor according to claim 5, wherein a distance between said first plane and said second plane is a first distance, and a rate of said maximum allowable clearance to said first distance is equal to or more than 5%.

7. The gas turbine combustor according to claim 5, wherein said first plane is formed to have a wave-like shape when a section of said first member is viewed along a direction of the flow of said cooling medium.

8. A method of manufacturing a cooling structure which comprises:
a first member as a cooling object having a first plane; and
a second member arranged above said first plane to have a second plane to oppose to said first plane such that a passage is formed between said first plane and said second plane for a cooling medium to flow,
wherein said first member comprises a plurality of prominences which extend upwardly from said first plane, and
wherein each of said plurality of prominences extend to be inclined along a direction in which said cooling medium flows,
wherein said method comprises:
measuring as a first relation, a relation of a clearance formed between a tip of said each prominence and said second plane and a heat transfer rate between said cooling medium and said first member, when said each prominence is inclined along a direction in which said cooling medium flows;
measuring as a second relation, a relation of a clearance and a heat transfer rate when said each prominence extends upwardly in a vertical direction from said first plane;
determining as a maximum allowable clearance, said clearance based on said first relation and said second relation such that said heat transfer rate when said each prominence is inclined becomes larger than said heat transfer rate when said each prominence extends upwardly in the vertical direction; and
providing said second member on said first plane such that a clearance between each of said plurality of prominences and said second plane is equal to or less than said maximum allowable clearance.
